(19) United States
(12) Patent Application Publication
(10) Pub. No.: US 2008/0077653 A1
(43) Pub. Date: Mar. 27, 2008

(54) Methods, systems, and computer program products for enabling dynamic content in a markup-language-based page using a dynamic markup language element

(76) Inventor: Robert P. Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/527,259

(22) Filed: Sep. 26, 2006

(51) Int. Cl. G06F 15/16

(52) U.S. Cl. 709/203

(57) ABSTRACT

Methods, systems, and computer program products for enabling dynamic content in a markup-language-based page using a dynamic markup-language element are disclosed. According to one method, a client detects, while parsing a markup-language-based page, a dynamic markup language element including presentation content. The dynamic markup language element identifies the presentation content as dynamic and specifies a remote update provider for providing an update to the presentation content. The client presents at least a portion of the page including the presentation content. The client sends a message to the remote update provider for an update to the presentation content. The client receives an update from update provider. The client updates the page by replacing at least a portion of the presentation content with the presentation content received from the update provider. The client presents the updated page.

### TECHNICAL FIELD

The subject matter described herein relates to enabling dynamic content in a markup-language-based page, such as a web page. More particularly, the subject matter described herein relates to methods, systems, and computer program products for enabling dynamic content in a markup-language-based page using a dynamic markup language element.

### BACKGROUND

Current web browsers present web pages to users by obtaining web page content from web servers, interpreting the content, and formatting the content for presentation to the users. Current web page content includes markup language elements, such as tags and attributes that instruct the browser on how to present the content; presentation content, such as text, audio, video, and image data; and scripts.

Scripts are programs, often written by a party other than the web browser provider, that are downloaded from a web server and executed within the web browser context to perform a function, such as obtaining updates to dynamic content. For example, a script may be downloaded with a stock quotes page to periodically contact a web server to obtain updated stock quotes. One problem with using scripts to obtain dynamic content is that scripts can be third party computer code that may be used for purposes other than that which is intended by the browser user. For example, scripts may gather information from a user's computer and return that information to a server without authorization from the user, get and set cookies unrelated to the user's purpose for retrieving a web page and plant or open spyware or other malicious executables on the user's computer.

Two examples of existing technologies that use scripts to obtain dynamic content are dynamic HTML (DHTML) and asynchronous Javascript and XML (AJAX). DHTML uses scripting to provide dynamic content, does not allow a page to be updated without a message to update an entire window or frame, and support is not standardized across browsers.

AJAX is a web development tool for creating interactive web applications. AJAX uses a combination of XHTML or HTML and cascading style sheets (CSS) to describe the presentation of a document in a markup language. AJAX uses a document object model (DOM) which describes in a tree structure how a document is presented. Like DHTML, AJAX uses client-side scripting to obtain dynamic content to be displayed in a page. While AJAX has found more standardized support than DHTML, AJAX still requires the use of scripting to enable dynamic content. Accordingly, the same problems discussed above with regard to executing third party code occur. That is, the code can be used for purposes that were not intended by the user of the browser.

Accordingly, in light of these difficulties associated with using scripting to enable dynamic web page content, there exists a need for improved methods, systems, and computer program products for enabling dynamic content in a web page.

### SUMMARY

The subject matter described herein includes methods, systems, and computer program products for providing dynamic content in a markup-language-based page using a dynamic markup language element. According to one aspect, a method for dynamically updating content in a markup-language-based page in a client is provided. The method includes, detecting, while parsing a markup-language-based page, a dynamic markup language element including presentation content. The dynamic markup language element identifies the included presentation content as dynamic to the client and specifies a remote update provider for providing an update to the presentation content. At least a portion of the markup-language-based page is presented including the presentation content. A message is sent to a remote update provider for an update to the presentation content. An update is received from the update provider. The page is updated by replacing at least a portion of the presentation content with the presentation content received from the update provider. The updated page is presented.

As used herein, the term “markup-language-based page” refers to any document or other resource whose presentation is defined using a markup language. Examples of markup-language-based pages include web pages for resources presented over the Internet and documents defined using a markup language for presentation over a corporate or other intranet.

The subject matter described herein for providing dynamic content in a markup-language-based page may be implemented using a computer program product comprising computer executable instructions embodied in a computer readable medium. Exemplary computer readable media suitable for implementing the subject matter described herein include disk memory devices, chip memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram of a system for enabling dynamic content in a markup-language-based page using a dynamic markup language element according to an embodiment of the subject matter described herein;

FIG. 2 is a block diagram illustrating a presentation controller, a presence content handler, a protocol agent, and an HTTP client protocol stack according to an embodiment of the subject matter described herein;

FIG. 3 is a message flow diagram illustrating exemplary messages exchanged between a browser, a markup-language-based page provider, and an update provider in enabling dynamic content in a markup-language-based page using a dynamic markup language element according to an embodiment of the subject matter described herein;

FIG. 4 is a message flow diagram illustrating exemplary messages exchanged between a browser, a markup-language-based page provider, and an update provider in providing dynamic content in a markup-language-based page using a dynamic markup language element according to an embodiment of the subject matter described herein;

FIG. 5 is a flow chart illustrating an exemplary process from a browser or other client perspective for enabling dynamic content in a markup-language-based page using a dynamic markup language element according to an embodiment of the subject matter described herein;

FIG. 6 is a flow chart illustrating an exemplary process from a markup-language-based page provider perspective for enabling dynamic content in a markup-language-based page using a dynamic markup language element according to an embodiment of the subject matter described herein;

FIG. 7 is a flow chart illustrating an exemplary process from an update provider perspective for enabling dynamic content in a markup-language-based page using a dynamic markup language element according to an embodiment of the subject matter described herein; and

FIG. 8 is a block diagram of an exemplary markup-language-based page or update provider for enabling dynamic content in a markup-language-based page using a dynamic markup language element according to an embodiment of the subject matter described herein.

### DETAILED DESCRIPTION

The subject matter described herein includes methods, systems, and computer program products for enabling dynamic content in a markup-language-based page using a dynamic markup-language-element according to an embodiment of the subject matter described herein. According to one aspect of the subject matter described herein, a dynamic markup language element identifies a portion of presentation content in a markup-language-based page as dynamic to the client that presents the page. The dynamic markup language element may be any suitable markup language element, such as a tag or an attribute of a tag. A dynamic markup language element that is implemented as a tag may be a hypertext markup language element (HTML) tag, an extensible markup language (XML) tag, or a tag defined in another suitable markup language. A dynamic markup language element that is implemented as an attribute may be an HTML attribute, an XML attribute, or any attribute defined in another suitable markup language. In one implementation, trusted code within a user's web browser or other client may interpret the dynamic markup language element and contact an update provider to obtain updates to the dynamic content. In an alternate implementation, the dynamic markup language element may include script that facilitates updates to dynamic content.

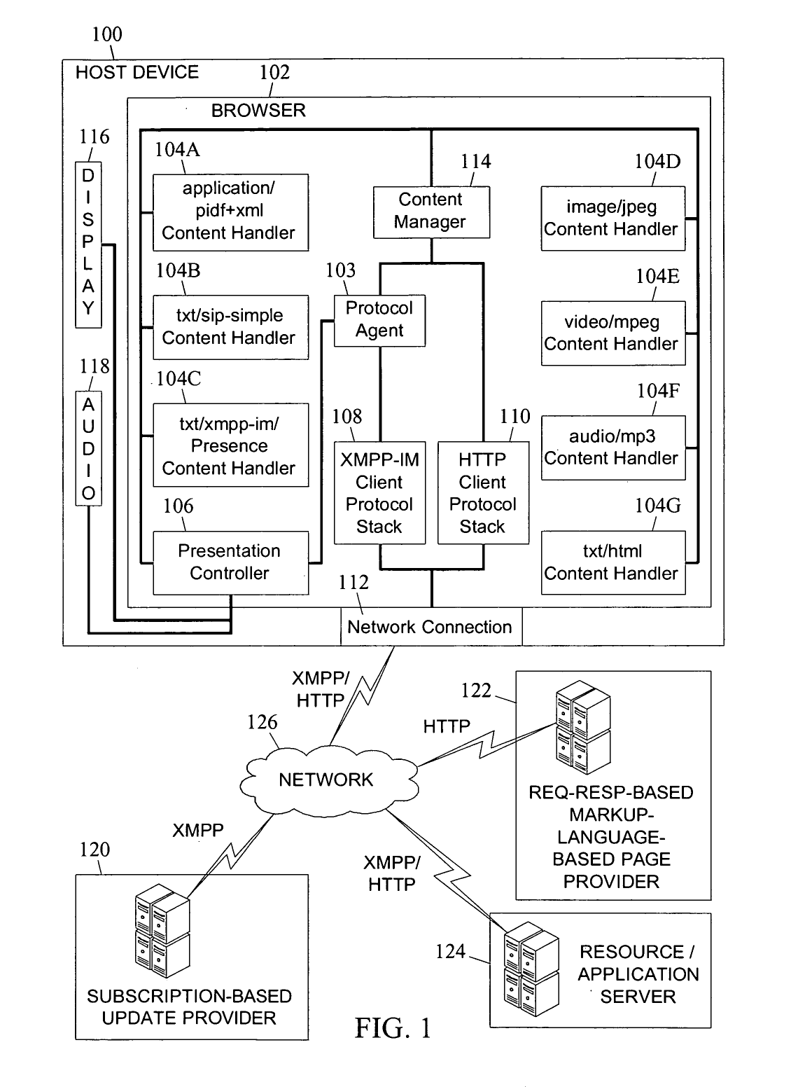

FIG. 1 is a block diagram illustrating an exemplary system for providing dynamic content in a markup-language-based page using a dynamic markup language element according to an embodiment of the subject matter described herein. Referring to FIG. 1, a host device 100 may be any suitable device capable of executing software for presenting markup-language-based pages. For example, host device 100 may be a personal computer, a smart phone, a personal digital assistant, or a mobile phone with audio, video, and/or conventional text and graphics markup-language-based page presentation capabilities. A web browser 102 may be software that executes on host device 100 for obtaining and presenting markup-language-based pages to a user. Browser 102 may include various components for obtaining and presenting the pages. In the illustrated example, these components include protocol agent 103, content handlers 104A-104G, presentation controller 106, extensible messaging and presence protocol-instant messaging (XMPP-IM) protocol stack 108, HTTP client protocol stack 110, network connection 112, and content manager 114.

Content manager 114 identifies the format or content type of incoming data received by browser 102 and distributes the data to the content handler associated with the identified content type. Content manager 114 may detect the format of incoming data by reading a multipurpose Internet mail extension (MIME) type indicator associated with the data. Messages from content handlers 104A-104G to external content services, for example, to obtain dynamic content, pass through content manager 114. Content manager 114 directs each message to a compatible protocol stack or protocol agent capable of communicating with the remote content or update provider. In the illustrated example, protocol agent 103 may communicate in any suitable protocol, such as the presence protocol. XMPP-IM protocol stack 108 may communicate with remote entities using, for example, a presence or real-time, publish-subscribe (pub-sub) protocol. Similarly, HTTP client protocol stack 110 may implement an HTTP client for communicating with remote entities using HTTP.

Content handlers 104A-104G handle content received from web servers in specific formats. For example, content handler 104A may parse and interpret presence information data format (PIDF), content handler 104B may parse and interpret session initiation protocol (SIP)-SIMPLE content, content handler 104C may handle text and XMPP-IM content, content handler 104D may handle image content in JPEG format, content handler 104E may handle video content, such as MPEG content, content handler 104F may handle audio content, such as MP3 content, and content handler 104G may handle text and HTML content. As stated above, content associated with a page may be identified using a MIME type associated with the content or may be determined by content manager 114 by processing at least a portion of the content. Each content handler 104A-104G may receive content that is associated with its specific MIME type(s), parse the content, and process the content for presentation to a user. Presentation controller 106 may control the presentation of content to a user via a display interface 116. Similarly, presentation controller 106 may control the presentation of audio information to a user via audio interface 118.

The subject matter described herein is not limited to presenting markup-language-based pages with dynamic content of the content types illustrated in FIG. 1. Additional content types that may be supported without departing from the scope of the subject matter described herein include Microsoft's RVP presence and instant messaging protocol, presence protocols provided by other parties, such as America Online and Yahoo, and an HTTP-compatible presence protocol as described in U.S. patent application Ser. No. 11/344,696, filed Feb. 1, 2006, the disclosure of which is incorporated herein by reference in its entirety.

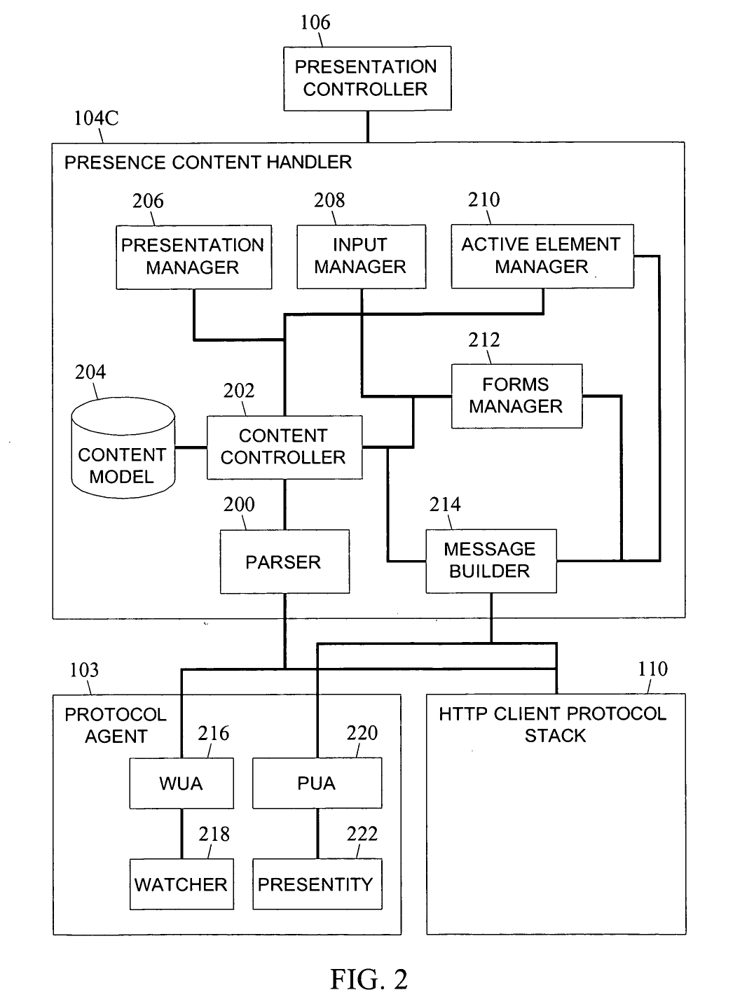

FIG. 2 is a block diagram illustrating in detail exemplary components of an exemplary content handler. In the illustrated example, components of presence content handler 104C are shown. Presence content handler 104C includes a parser 200, a content controller 202, a content model 204, a presentation manager 206, an input manager 208, an active element manager 210, a forms manager 212, and a message builder 214. Parser 200 receives incoming content and converts the content into a format usable by other components of presence content handler 104C. Parser 200 may receive content from a protocol application layer and/or protocol agent 103 through content manager 114 illustrated in FIG. 1.

Content controller 202 receives content output from parser 200 and serves as the hub for content handler 104C. Content controller 202 stores data received from the parser 200 in a content model 204 for later access. For XML-based content including HTML and its variants, content model 204 may be a DOM repository, which enables content controller 202 and other components of content handler 104C to locate, add, update, delete, move, and otherwise manipulate the elements, attributes, and content of received data. Manipulation is performed in current browsers via scripts, usually embedded in content which are passed to a scripting engine for execution. According to one aspect of the subject matter described herein, dynamic markup language elements are used to trigger or otherwise facilitate the obtaining of updates to dynamic content.

The remaining elements of presence content handler 104C further process incoming or outgoing data. For example, presentation manager 206 may control presentation of received content via presentation controller 106. Input manager 208 and forms manager 212 may receive input from a user for content displayed. Message builder 214 builds messages for dynamic content and passes the messages to the appropriate protocol agent or protocol stack. Active element manager 210 detects the presence of dynamic content in a received page and controls message builder 214 to format a message to an update provider for obtaining an update to the dynamic content.

Protocol agent 103 contains entities for communicating with remote update providers. In the illustrated example, protocol agent 103 includes a watcher user agent 216, a watcher 218, a presentity user agent 220, and a presentity 222. Watcher user agent 216 and watcher 218 obtain updates to dynamic content from a subscription-based remote update provider. Presentity user agent 220 and presentity 222 provide publish information to a remote server. Exemplary operations performed by watchers, presentities, and their associated user agents are described in IETF RFCs 2778 and 2779, the disclosure of each of which is incorporated herein by reference in its entirety. A protocol agent may have multiple watchers, presentities, watcher user agents, and presentity user agents without departing from the scope of the subject matter described herein.

In contrast to the presence or publish-subscribe protocol, which is subscription-based, HTTP client protocol stack 110 obtains updates from remote update providers using the HTTP protocol, which is not subscription-based. Rather than using a subscription, the HTTP protocol uses a request-response interaction action model to issue HTTP messages such as a get message for each item of information to be obtained from a web server. For example, in response to a get message, the web server will send the resource requested by the get message. New get messages must be sent in order to receive updated content.

Returning to FIG. 1, various types of entities may provide markup-language-based page content and updates to the content. In the illustrated example, a subscription-based update provider 120 provides updates to content being presented by a browser using a subscription-based protocol, such as supported by XMPP. A request-response-based markup-language-based page provider 122 provides markup-language-based content to be presented by browser 102 via a request-response-based protocol, such as HTTP. A resource/application server 124 provides markup-language-based pages and updates to dynamic content using both subscription-based protocols, such as XMPP-based presence and publish-subscribe protocols, and request-response-based protocols, such as HTTP. Communication between host device 100 and content providers 120, 122, and 124 may occur over a network 126. Network 126 may be any suitable network that supports packet-based-communication, such as TCP/IP or UDP/IP communication.

In one implementation, the dynamic markup language element that identifies content as dynamic may be a markup language tag. The following example below illustrates markup language for a web page that includes a dynamic markup language tag identifying associated presentation content as dynamic:

EXAMPLE 1
Document URL=pub-sub://helloWorld@unreal.net

```
<!doctype HTML PUBLIC “-//W3C//DTD HTML 4.01//EN”
    “http://www.w3.org/TR/htmlX/strict.dtd”>
<html>
    <head>
        <title>My first HTML document</TITLE>
    </head>
    <dynamic source=”pub-sub://helloWorld@unreal.us/body” >
    <body>
        <p>Hello world!</p>
    </body>
    </dynamic>
</html>
```

In the example above, the <dynamic> tag identifies the content within the tag delimiters as dynamic. The remote update provider is specified by the URL pub-sub://helloWorld@unreal.us/body. When a content handler, such as content handler 104C, encounters the <dynamic> tag, the content handler will contact the source specified by the URL to obtain the dynamic content. In the example above, the web page will initially display the text, “Hello World!”. The browser will then contact a remote update provider via a command to establish a subscription. The remote update provider will provide an update to the text to replace the original text when an update occurs or is received from a publisher. For example, the update for the text may specify “Hello North Carolina!” when the user's IP address is determined to be assigned to an entity in North Carolina.

In an alternate implementation, rather than using a markup language tag to identify presentation content as dynamic, a dynamic attribute may be used. The following example illustrates the use of a dynamic attribute to identify the associated content as dynamic to the browser:

EXAMPLE 1A
Document URL=pub-sub://helloWorld@unreal.net

```
<!doctype HTML PUBLIC “-//W3C//DTD HTML 4.01//EN”
    “http://www.w3.org/TR/htmlX/strict.dtd”>
<html>
    <head>
        <title>My first HTML document</TITLE>
    </head>
    <body dynamic=”TRUE” source=”pub-
sub://helloWorld@unreal.us/body”>
        <p>Hello world!</p>
    </body>
</html>
```

In the example above, the dynamic attribute of the <body> tag identifies the content as dynamic to the browser and also identifies the remote source. The processing of such a tag to obtain the update to the content is the same as that described above for the dynamic attribute.

Presentation of web page content may be performed using presentation manager 206 illustrated in FIG. 2 using content model data 204 provided by content controller 202. Presentation manager 206, in the case of XML-based content, interprets element and content data in order to format and present a portion of the content using a browser presentation subsystem, such as display interface 116 and audio interface 118 illustrated in FIG. 1.

In Example 1 above, the <dynamic> tag that encloses the HTML <body> tag indicates to content handler 104A that the <dynamic> tag and its content are updatable. The source attribute in the <dynamic> tag indicates that an update provider may be located using the specified URL, pub-sub://helloWorld@unreal.us/body.

Presentation manager 206, in conjunction with presentation interfaces 116 and/or 118, presents portions of the content as specified by the elements including presentation content contained within the detected dynamic element.

The web page being displayed is updatable since notifications associated with subscriptions or responses associated with, for example, get messages may be received replacing all or portions of the page from data associated with the document URL. A dynamic element in an updatable page can inherit attributes of its page or enclosing dynamic elements if the attribute is not specified in the element itself. A dynamic element may override an attribute associated with its page or an enclosing dynamic element by specifying the attribute and value in the element. For example, a source attribute's value may indicate that an update for the associated element and content is available using a published-subscribe protocol, which may be different than the publish-subscribe protocol of the containing page or element and may be from a different source. Each update may have different attributes and values, since the dynamic element is updatable. A dynamic element and its contents may even be replaced with a non-dynamic element with or without content, at which point the replaced portion of the document is no longer updatable. The protocol used for the dynamic element may be of any suitable type and is not required to be of the same protocol as the protocol used in the receiving element's container element and content. For example, a pub-sub source attribute of a dynamic element may be replaced with a request-response-based source attribute or vice-versa.

In addition to providing data to presentation manager 206 illustrated in FIG. 2 for presentation, content controller 202 provides information concerning updatable elements to active element manager 210 illustrated in FIG. 2. Active element manager 210 uses the identified update provider address information (e.g., a URL) to enable the reception of updated elements and their content. If the update provider source is a subscription provider as in Example 1 above, active element manager 210 provides information from the source identifier and the DOM to enable message builder 214 to send a subscription message to the identified source enabling the reception of a notify message including an updated element and/or content using the protocol identified. When a subscribe message is sent to an update provider, the path identifier may be provided in a DOM object for the updatable element and its content to uniquely identify the updatable element. Alternately, each element can be assigned an id attribute with unique values for purposes of identifying the updatable element. The subsequent notify message may be received from the subscription service, for example as a result of a publish command from a publisher, if the service is a publish-subscribe or presence service. Alternatively, the notify message may be generated internally by the subscription service, for example.

If the update provider does not support notifications or if the URL is associated with a request-response protocol, such as HTTP, active element manager 210 provides information to message builder 214 to build and send a command using a request-response interaction model, which in the case of HTTP, for example, is a get command to retrieve the updated data. The response may contain updated data including elements, which may be the same elements and data if no update has occurred, or, an indicator that no updates are available.

In Example 1 above, content controller 202 provides the URL pub-sub://helloWorld@unreal.us/body, a path identifier associated with the location of the dynamic elements to active element manager 210. Active element manager 210 invokes message builder 214 using information in the URL and path identifier. Message builder 214 builds a subscription message using the format of the identified protocol and sends the subscription message to an update provider. The message may be sent via protocol agent 103 to a protocol stack. The protocol stack may communicate with the remote update provider using network communication protocols, such as HTTP or a presence/publish-subscribe protocol.

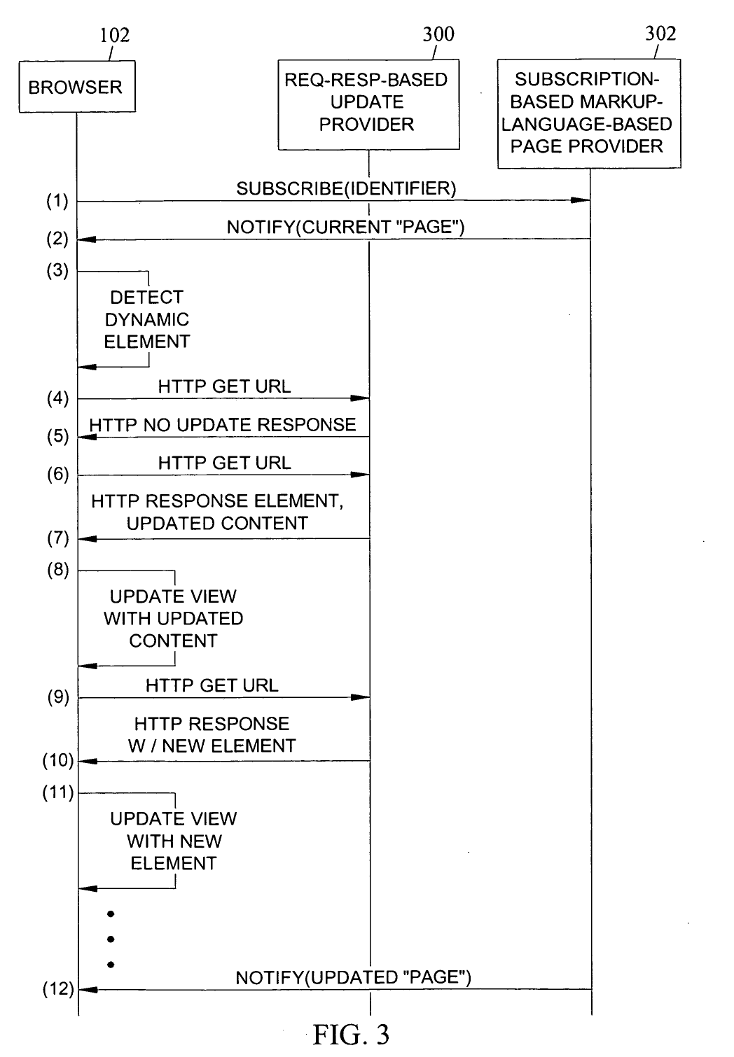

As described above, in obtaining the initial markup-language-based page including the dynamic content and obtaining updates to the dynamic content, a content handler may use a pub-sub protocol or a request-response based protocol. FIG. 3 is a message flow diagram illustrating exemplary messages exchanged between browser 102, a request-response-based update provider 300, and a subscription-based markup-language-based page provider 302. Referring to FIG. 3, in line 1, browser 102 sends a subscribe message to subscription-based markup-language-based page provider 302 for obtaining a markup-language-based page that includes dynamic content. In line 2, subscription-based markup-language-based page provider 302 provides the markup-language-based page including the dynamic content to browser 102 via a notify message. In line 3, browser 102 detects a dynamic element in the page.

In this example, it is assumed that browser 102 includes code for obtaining the dynamic element using a request-response-based protocol, such as HTTP. Accordingly, in line 4, browser 102 sends an HTTP get message to the URL specified by the dynamic element. The get message is sent to request-response-based update provider 300. In line 5, request-response-based update provider 300 responds with an HTTP message indicating that no update is currently available.

Browser 102 may include code that continually requests the update. Accordingly, in line 6, browser 102 sends another get message to update provider 300. In line 7, update provider 300 responds with the updated content. In line 8, browser 102 updates the display of the markup-language-based page with the new content. In lines 9-10, browser 102 obtains an update with a new or modified dynamic tag or attribute from update provider 300. In line 11, browser 102 updates the display of the markup-language-based page with the new content, if any, and makes the new or modified dynamic element or attribute active. This process can continue. Since the page was obtained via a subscription in line 1, the page itself is updatable. Line 12 depicts the subscription-based markup-language-based page provider 302 sending a notify message with a new or update page to browser 102 for processing.

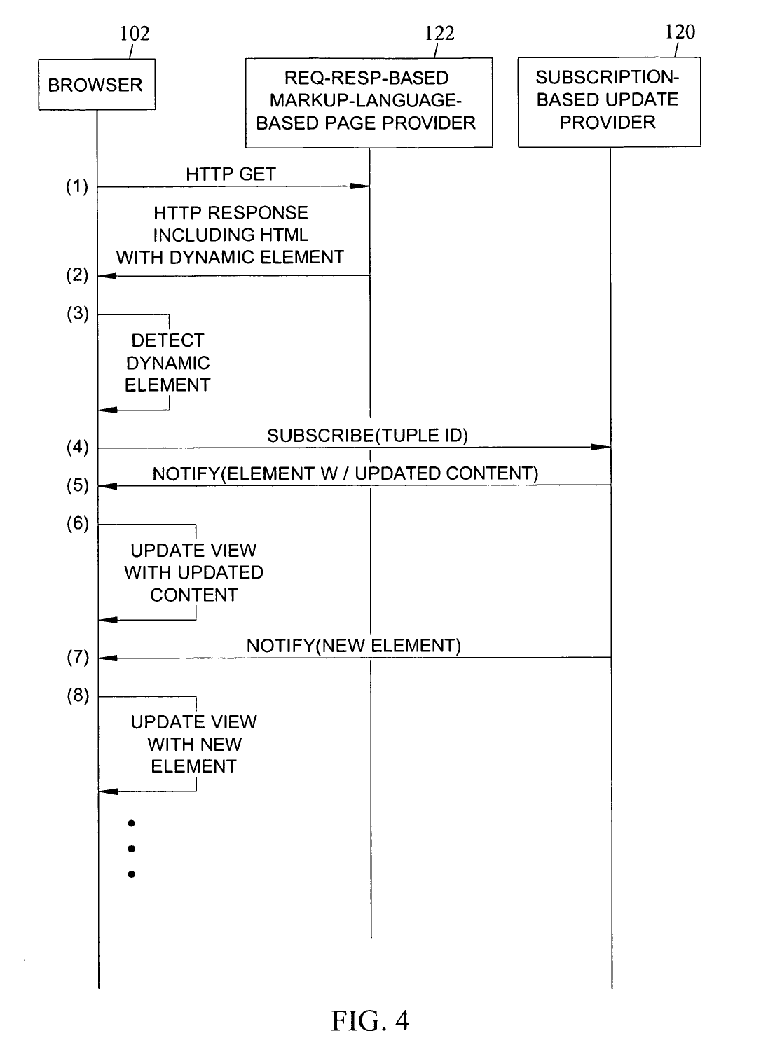

FIG. 4 is a message flow diagram illustrating exemplary messages where a browser obtains an initial markup-language-based page from request-response-based markup-language-based page provider 122 and obtains updates for dynamic content from subscription-based update provider 120 illustrated in FIG. 1. Referring to FIG. 4, in line 1, browser 102 sends an HTTP get message for obtaining the initial page to request-response-based markup-language-based page provider 122. In line 2, markup-language-based page provider 122 sends an HTTP response message including an HTML-encoded markup-language-based page with a dynamic markup language element. In line 3, browser 102 detects the dynamic markup language element. Browser 102 may display the markup-language-based page with the initial value for the dynamic markup language element. In line 4, browser 102 sends a subscribe message to subscription-based update provider 120. Subscription-based update provider 120 responds in line 5 with a notify message including the updated content. In line 6, browser 102 updates the display of the markup-language-based page with the updated content. In line 7, subscription-based update provider 120 sends a notification message associated with the subscribe message in line 4 where the notify includes a new or updated dynamic element and may include new content for the new dynamic element. In line 8, browser 102 updates the view of the markup-language-based page with the new content, if any, and makes the new or updated dynamic element active. Display of the dynamic content and update of the associated dynamic element may be updated each time browser 102 receives new data from subscription-based update provider 120.

Returning to FIGS. 1 and 2, receipt of an update from an update provider and subsequent presentation by a browser 102 may be accomplished using the appropriate protocol stacks and presentation managers. For example, in FIG. 3, the browser 102 receives updated data associated with the dynamic element and its content via a notify message from the update provider. The notify message is passed through a protocol stack including an application layer. In this example, the application layer may be a publish-subscribe layer provided by presence content handler 104C. Parser 200 parses the content of the notification message and passes the output to content controller 202. Content controller 202 correlates the data with the subscription associated with the subscribe message, detects the presence of an update identifier if present, and detects any content in the message. Whether there is an update identifier present in the notify message or not, content controller 202 may update content model 204 or the DOM using the data received from parser 200.

In updating the page, content controller 202 may invoke presentation manager 206 providing data based on the update of the DOM object. Content controller 202 may provide data needed to update changed portions of the presentation. Alternatively, content controller 202 may replace the entire portion of the presentation content.

Presentation manager 206 processes the data received from content controller 202, identifies the portion of the presentation content to update, and calls the browser's presentation controller 106. The browser's presentation controller 106 coordinates the presentation across all content handlers involved to update portions affected by the update. Presentation controller 106 may invoke a library, such as a GUI library provided in association with an operating system and its presentation subsystems.

If the updated content received includes an updatable portion which has the same source provider or URL, as detected by active element manager 210, which is updated when update information is received, active element manager 210 may leave the current subscription active in preparation for a new notify message with updated data. This process may continue indefinitely, as illustrated by the example in FIG. 3.

The updated data may contain a new update provider. In this case, active element manager 210 cancels the current subscription and sends a message to the new update provider using the URL provided and optionally information from the DOM and/or from the update element. The update identifier in the update may be in the same location as the previous update identifier or may appear within the update data.

Updates may add new update identifiers, alter source providers, or alter other attributes of a dynamic element. Updates may add additional dynamic markup language elements to content and/or remove markup language dynamic elements in previous content. The update information may contain no updatable portions. Once this happens, the portion is only updatable if it is contained within an updateable portion in a higher level of the DOM object.

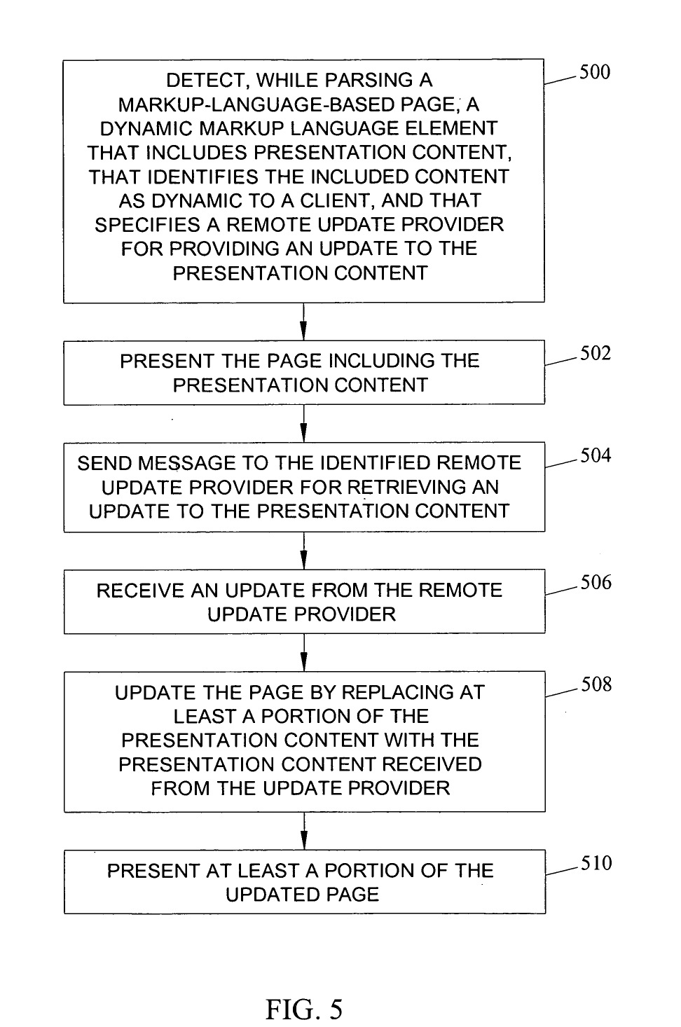

FIG. 5 is a flow chart illustrating an exemplary process from the perspective of a client for enabling dynamic content in a markup-language-based page using a dynamic markup language element according to an embodiment of the subject matter described herein. Referring to FIG. 5, in block 500, a client detects, while parsing a markup-language-based page, a dynamic markup language element that includes presentation content. Presentation content may be defined to include an empty element. For example, no content may be specified for an updatable <body> element within a <dynamic> element. Alternatively, default content may be specified for the <body> element within the <dynamic> element. The dynamic markup language element identifies the included content as dynamic to the client and specifies a remote update provider for providing an update to the dynamic content. In block 502, at least a portion of the page is presented including the presentation content.

In block 504, the client sends a message to the identified remote update provider for retrieving an update to the presentation content. In block 506, the client receives an update for the presentation content from the update provider. In block 508, the page is updated by replacing at least a portion of the presentation content with the presentation content received from the update provider. In block 510, the updated page is presented. For example, if the page contains visual information, that information may be displayed on a visual display interface. If the page contains audio information, the audio information may be presented or played to the user via an audio display interface.

Although the examples described above use a browser in the role of a client to detect a dynamic markup language element and obtain the corresponding update to the presentation content, the subject matter described herein is not limited to using a web browser as the client. Other client types that read, parse, and display a declarative markup language element can be used to detect and process a dynamic markup language element without departing from the scope of the subject matter described herein. For example, a word processor that reads a file stored in OpenDoc, an XML standard for documents used by, for example, the OpenOffice suite's word processor, may be extended to support dynamic markup language elements and their content when provided an update source which is either local or remote to the word processor instance processing the document with the dynamic element.

According to one enhancement of the subject matter described herein, in addition to receiving updated presentation content, browser 102 and associated content handlers 104 may receive an identifier for a new remote update provider for receiving new updates to the presentation content. Browser 102 may use the new update provider for the next update. Each update may specify a new update provider so that dynamic content is provided from multiple locations.

According to another enhancement of the subject matter described herein, the update may replace attributes associated with the markup language element. For example, the update may add or replace a timer related attributed of the element in addition to replacing the body portion of the markup language element in Example 1 above.

According to another enhancement of the subject matter described herein, the dynamic markup language element that identifies content as dynamic may identify an alternate source from which an update to the presentation content may be obtained. The alternate source may be contacted if the browser does not support the protocol specified by the initial update provider. The following example illustrates the specification of an alternate source in a dynamic markup language element:

EXAMPLE 2
Document URL=http://www.unreal.net/helloWorld.html

```
<!doctype HTML PUBLIC “-//W3C//DTD HTML 4.01//EN”
    “http://www.w3.org/TR/htmlX/strict.dtd”>
<html>
    <head>
        <title>My first HTML document</TITLE>
    </head>
    <dynamic source=”pub-sub://helloWorld@unreal.net/body”
                  altsource=”http://unreal.net/helloWord/body”
                  altTimer=“10s”>
    <body>
        <p>Hello world!</p>
    </body>
    </dynamic>
</html>
```

In Example 2 above, the altsource attribute specifies an alternate URL for obtaining the update. The alternate source may be used if the browser does not support the pub-sub source specified by the first URL.

Another enhancement of the subject matter described herein illustrated by Example 2 above is the use of the alttimer attribute to specify the time interval at which updates will be obtained from the alternate source when a request-response protocol is used as in Example 2. In an alternate implementation, a reoccurring time value, such as a GMT time value, may be used to define the time at which updates should be obtained from the update provider.

According to another enhancement of the subject matter described herein, a conditional expression may be used to trigger the contacting of the update provider. For example, browser input events may be used as inputs to conditional expressions that trigger the contacting of the update provider. The conditional expression may indicate that if a specified element value in another portion of the page, including another updateable portion, matches a specified element in the updateable portion associated with the dynamic element, then the update provider will be contacted. The conditional expression may be part of the dynamic element or may be separate from the dynamic element and its associated content.

According to another enhancement of the subject matter described herein, a browser may support default values for a portion of an updatable element's attributes and allow the defaults to be overridden by attributes received from the update provider. A user or an executable internal to the browser may be allowed to set the default attribute values for updateable elements, as well as indicating whether the defaults may or may not be overridden.

According to another aspect of the subject matter described herein, a dynamic markup language element may include a script that may be replaced by a script from an update provider or by other dynamic or non-dynamic content from the update provider. Thus, while dynamic markup language elements eliminate the need for scripts to enable dynamic content, the subject matter described herein does not preclude the use of scripts in combination with dynamic markup language elements to enable dynamic content.

According to another enhancement of the subject matter described herein, a dynamic markup language element may be identified by the element's position in a containing document's DOM object or by using an identifier. Example 3 shown below illustrates an exemplary updatable portion document and the associated pub-sub URL from which the document was obtained.

EXAMPLE 3
URL=pub-sub://somedoc@unreal.net/dynamicList

<dynamic id=“aList”>
<ul>
<li>Unordered information. </li>
<li>Ordered information. ,/li>
<li>Definitions. </li>
</ul>
</dynamic>

When a subscription or a request message is sent to the update provider, the updatable element may be identified by its position or path in the containing document's DOM object. In addition, an identifier may be used to distinguish between elements within the same document including dynamic elements as supported. In Example 3, an identifier “aList” associated with the updatable element is used to identify the updatable element to the update provider receiving a message for retrieving an update for the element. The attribute “id” can be used to indicate to the update provider the unique identity of an updatable element as supported by markup-languages, such as versions of HTML. Alternatively, information identifying the containing document or element can be provided to the update source if “id” values are unique only within the context of the containing document or element. If a service provides a single type of updates, and an identifier for the service is available to the client, then document and element specific identification information is not required in the message to the update provider.

According to another enhancement of the subject matter described herein, a <dynsegment> markup language element can be used to set values and/or update providers for a plurality of dynamic elements included in the dynsegment element. In addition, <dynsegment> elements can be nested to set different values for enclosed dynamic elements. Example 4 shown below illustrates an exemplary use of a <dynsegment> element.

```
EXAMPLE 4
<dynsegment source=“pub-sub://randomsource@unreal.net”>
<table border=“1”
    summary=“This table has prices of fruit in our store.”>
<CAPTION><EM>Current Fruit Prices</EM></CAPTION>
<TR><TH>Fruit</TH><TH>Price</TH></TR>
<TR><TD>Apples</TD><dynamic><TD>$0.99 per lb</TD>
          </dynamic></TR>
<TR><TD>Oranges</TD><dynamic><TD>3 for $2</TD>
            </dynamic></TR>
<TR><TD>Bananas</TD><dynamic><TD>$0.49 per lb</TD>
            </dynamic></TR>
<dynamic path=/exotic>
<TR><TD>Star Fruit</TD><dynamic><TD>$2 each</TD>
            </dynamic></TR>
</dynamic>
</table>
</dynsegment>
```

In Example 4, the <dynsegment> element allows a single update provider source to be specified for a plurality of dynamic elements and content where the update provider is not the same provider for the containing document or element. The <dynsegment> element relieves the page creator from having to repeat the source attribute in every updatable element.

Example 4 uses the <dynsegment> element to provide a source attribute and value that are applied to all dynamic elements contained within the <dynsegment> element which have no explicitly identified source. The scope of a <dynsegement> element may conform to XML rules when used in XML documents.

The <dynsegment> element is not limited to providing a value for the update provider. A <dynsegment>may element specify any attribute value associated with a <dynamic> element included in the <dynsegment> element. Setting a value for an attribute using a <dynsegment> element works as described above for the “source” attribute. The use of the “source” attribute described is exemplary. Thus, a <dynsegment> element does not require the specification of “source” attribute value and can be used to specify values for others attributes, such as the “summary” attribute in Example 4.

A first <dynsegment> markup language may be detected by a content handler while parsing the markup-language-based page. The first <dynsegment> markup language element may specify at least one attribute-value pair for establishing at least one default value for at least one attribute for <dynamic> markup language elements within the first <dynsegment> markup language element. For example, the first <dynsegment> markup language element may specify that all included <dynamic> markup language elements will have source=abccorp.com.

The content handler may detect a second <dynsegment> markup language element while parsing the markup-language-based page. The second <dynsegment> markup language element may be included within the first dynamic segment markup language element. The second <dynsegment> markup language element may specify at least one attribute-value pair for establishing at least one default value for at least one attribute for <dynamic> markup language elements within the second <dynsegment> markup language element. For example, the second <dynsegment> markup language element may specify that <dynamic> elements within the second <dynsegment> markup language element have the attribute altsource=xyzcorp.com. Thus, <dynamic> elements within both the first and second <dynsegment> markup language elements will have the attributes source=abccorp.com and altsource=xyzcorp.com. <dynamic> elements that are within the first <dynsegment> markup language element but not the second will have the attribute source=abccorp.com with no alternate source specified.

In Example 4 above, the attribute path in element <dynamic path=“/exotic> is an optional attribute that can be used to modify the source attribute in the <dynsegment> element, such that the source for the element with path modifier “/exotic” becomes pub-sub://randomsource@unreal.net/exotic.

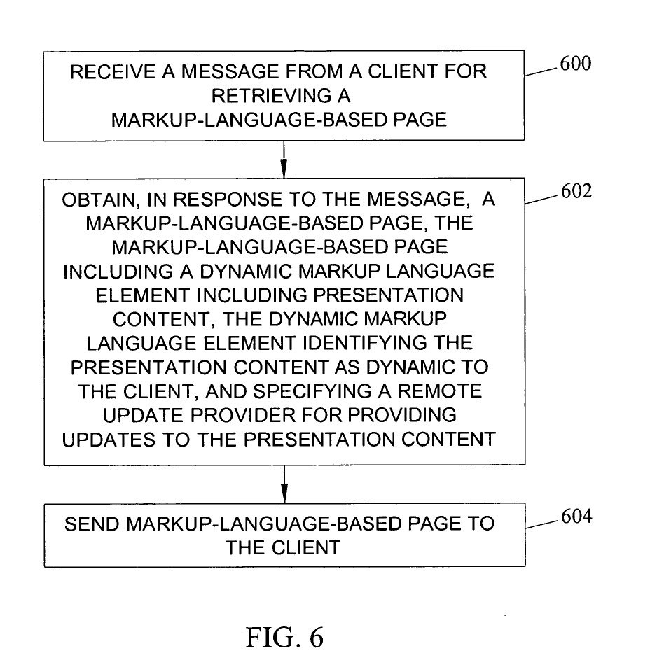

According to another aspect of the subject matter described herein, a method for providing markup-language-based pages with dynamic elements is provided. The method may be implemented by a subscription-based markup-language-based page provider, such as markup-language-based page provider 302 illustrated in FIG. 3 or by a request-response-based markup-language-based page provider, such as request-response-based markup-language-based page provider 122 illustrated in FIG. 1. FIG. 6 is a flow chart illustrating an exemplary process for providing markup-language-based pages including dynamic content to be presented by a client from a markup-language-based page provider perspective according to an embodiment of the subject matter described herein. Referring to FIG. 6, in block 600, a message for a markup-language-based page is received from a client. In block 602, in response to the message, a markup-language-based page is obtained (i.e., generated locally or received from a remote source). The markup-language-based page includes a dynamic markup language element including presentation content. The dynamic markup language element identifies the presentation content as dynamic to the client and specifies a remote update provider for providing updates to the presentation content. In block 604, the markup-language-based page is sent to the client.

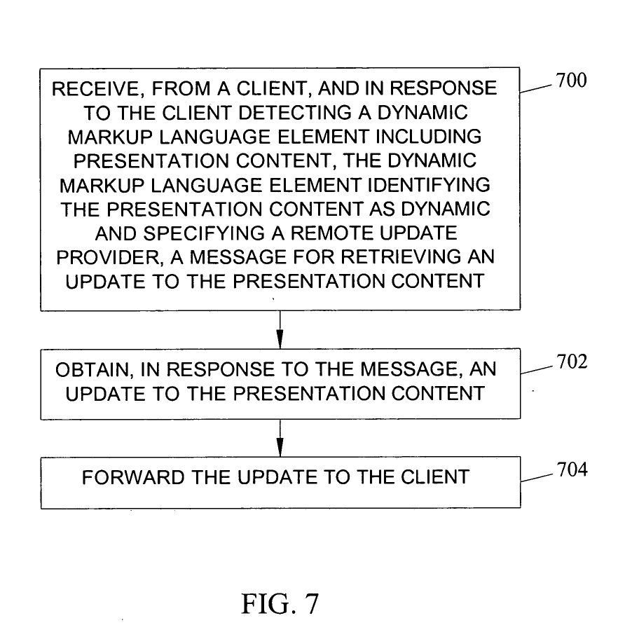

According to another aspect of the subject matter described herein, a method for providing dynamic updates to presentation content presented by a markup-language-based client is provided. Such a method may be implemented by subscription-based update provider 120 illustrated in FIG. 1 or by request-response-based update provider 300 illustrated in FIG. 3. FIG. 7 is a flow chart illustrating an exemplary process for providing dynamic updates to presentation content presented by a markup-language-based client from an update provider perspective according to an embodiment of the subject matter described herein. Referring to FIG. 7, in block 700, a message is received from a markup-language-based client in response to the client detecting a dynamic markup language element including presentation content. The dynamic markup language element identifies the presentation content as dynamic to the client and specifies a remote update provider. The message is for an update to the presentation content. In block 702, an update to the presentation content is obtained (i.e., generated locally or received from a remote source) in response to the message. In block 704, the update is forwarded to the client.

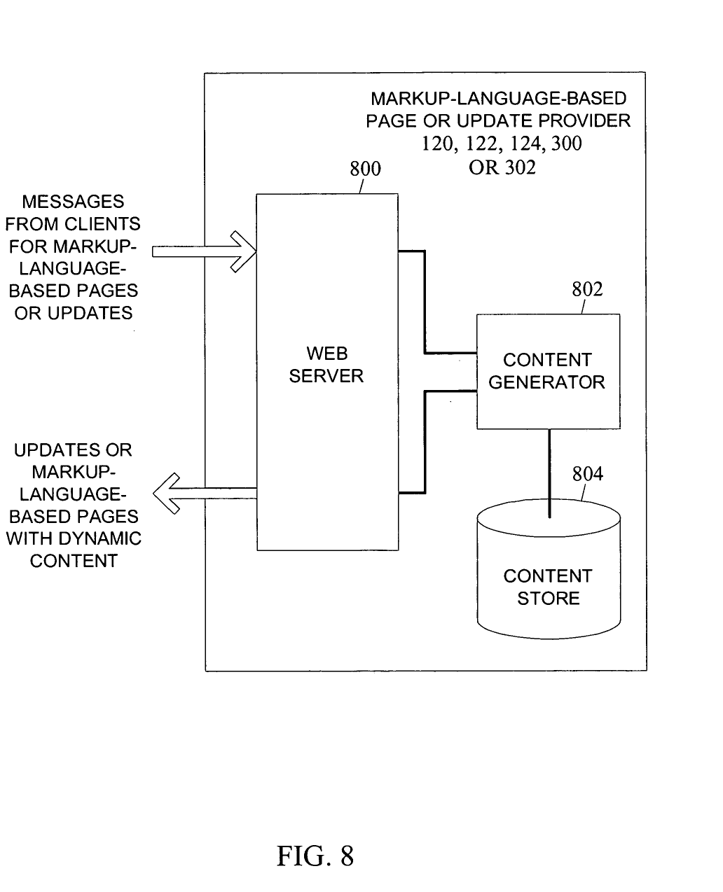

As stated above, an update provider or a markup-language-based page provider may facilitate delivery of updates to dynamic content being presented by a client or may facilitate delivery of markup-language-based pages that include dynamic markup language elements. FIG. 8 is a block diagram illustrating exemplary components of a markup-language-based page or update provider for performing these functions according to an embodiment of the subject matter described herein. Referring to FIG. 8, markup-language-based page or update provider 120, 122, 124, 300, or 302 may include various components for processing messages from browsers or other clients and for sending updates or markup-language-based pages with dynamic content in response to the message. In the illustrated example, a web server 800 is provided to process messages from clients for markup-language-based pages or updates. Web server 800 may be implemented using standard web server protocols, including a request-response protocol, such as HTTP, or a subscription-based protocol, such as a presence or publish-subscribe protocol. Web server 800 may include the appropriate TCP/IP or UDP/IP protocol stack for communicating with other entities over a network. Web server 800 may, in response to a message for a browser for an update, provide an update to dynamic content by communicating the message to content generator 802. Content generator 802 may be an application that provides updates to dynamic content using data stored in content store 804. In one example, content generator 802 can be a web application, and content store 804 can include page templates, including templates for dynamic portions of pages. In one implementation, content store 804 may include a database for storing the page templates. For messages for web pages or updates, content generator 802 may provide the requested content to web server 800. Web server 800 may deliver the updates or markup-language-based pages with dynamic content to the browser that sent the message.

According to one aspect of the subject matter described herein, a system for enabling dynamic content using a dynamic markup language element is provided. The system may include means for detecting, while parsing a markup language-based page, a dynamic markup language element including presentation content. The dynamic markup language element may identify the presentation content as dynamic to a client and may specify a remote update provider for providing an update the presentation content. For example, any of content handlers 104 illustrated in FIG. 1 may parse a received web page, identify a dynamic markup language element, and contact either a request-response-based update provider or a subscription-based update provider for obtaining updates to the content. The system may further include means for presenting at least a portion of the markup-language-based page including the presentation content. For example, presentation controller 106 illustrated in FIG. 1 may present a web page or other markup-language-based page to a user. The system may further include means for sending a message to the remote update provider for an update to the presentation content and receiving an update from the update provider. For example, any of content handlers 104 illustrated in FIG. 1 may send a request message or a subscribe message to an update provider for obtaining an update for the presentation content being presented by the client and may receive updates from the update provider. The system may further include means for updating the page by replacing at least a portion of the presentation content with the presentation content received from the update provider. For example, presentation controller 106, working with one of the content handlers 104, may update the page by replacing all or part of the information within a dynamic element with information received from the update provider. The system may further include means for displaying the updated page. For example, presentation controller 106 may present an updated page to a user.

According to another aspect, the subject matter described herein may include a system for providing dynamically updatable content to a client. The system may include means for receiving a message from a client for retrieving a markup-language-based page. For example, request-response-based update provider 300 or subscription-based update provider 120 may receive a message from a browser for a web page or other markup-language-based page. The system may further include means for obtaining (i.e., generating locally or receiving from a remote source), in response to the message, a markup-language-based page, where the markup language-based page includes a dynamic markup language element including presentation content. The dynamic markup language element may identify the included presentation content as dynamic to the client and may specify a remote update provider for providing updates to the presentation content. For example, request-response-based markup-language-based page provider 122 or subscription-based markup-language-based page provider 302 may generate a message including a markup-language-based page with dynamic content. The system may further include means for sending the markup-language-based page to the client. For example, request-response-based markup-language-based page provider 122 or subscription-based markup-language-based page provider 302 may send a message including the web page or other markup-language-based page to a user.

According to another aspect, the subject matter described herein may include a system for providing dynamic updates to presentation content presented by a client. The system may include means for receiving, from a client, and in response to the client detecting a dynamic markup language element including presentation content, a message for an update to the presentation content. The dynamic markup language element may identify the presentation content as dynamic to the client, and specify the update provider. For example, request-response-based update provider 300 or subscription-based update provider 120 may receive a message from browser 102 for retrieving an update to presentation content being displayed by the browser. The system may include means for, in response to the message, obtaining (i.e., generating locally or receiving from a remote source) an update to the presentation content. For example, request-response-based update provider 300 or subscription-based update provider 120 may generate and/or obtain dynamic presentation content to be provided to browser 102. The system may further include means for sending the update to the client. For example, request-response-based update provider 300 or subscription-based update provider 120 may forward a message including an update to dynamic content to the browser.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

1. A method for dynamically updating content in a markup-language-based page at a client, the method comprising:
detecting, while parsing a markup-language-based page, a dynamic markup language element including presentation content, the dynamic markup language element identifying the included presentation content as dynamic to the client and specifying a remote update provider for providing updates to the presentation content;
presenting at least a portion of the markup-language-based page that includes the presentation content;
sending a message to the remote update provider for an update to the presentation content;
receiving an update from the update provider;
updating the page by replacing at least a portion of the presentation content with the presentation content received from the update provider; and
presenting at least a portion of the updated page.

2. The method of claim 1 wherein the dynamic markup language element includes a markup language tag for identifying content within the tag as dynamic.

3. The method of claim 1 wherein the dynamic markup language element comprises an attribute of a markup language tag, the attribute including a value for identifying content within the tag as dynamic.

4. The method of claim 1 wherein sending a message to a remote update provider includes sending a subscribe message to the remote update provider for subscribing to receive the update to the presentation content.

5. The method of claim 1 wherein sending a message to the remote update provider includes sending a get message to the remote update provider for retrieving the update to the presentation content.

6. The method of claim 1 wherein receiving an update includes receiving an update for the dynamic markup language element and the presentation content.

7. The method of claim 1 wherein receiving an update includes receiving an update that specifies a new remote update provider for providing a subsequent update to the presentation content.

8. The method of claim 1 wherein receiving an update includes receiving an update including content for altering an attribute associated with the dynamic markup language element in addition to the presentation content.

9. The method of claim 1 wherein detecting a dynamic markup language element includes detecting a dynamic markup language element including an alternate source for providing an update to the presentation content, the alternate source using a different protocol than the update provider.

10. The method of claim 1 wherein detecting a dynamic markup language element includes detecting a dynamic markup language element including at least one of an attribute specifying a timer value defining an interval at which updates to the presentation content should be obtained from the update provider, an attribute specifying a time value defining a re-occurring time at which updates to the presentation content should be obtained from the update provider, and a conditional expression specifying a condition that, when satisfied, triggers sending of the message to the update provider to obtain the updated presentation content.

11. The method of claim 1 comprising detecting a first dynamic segment markup language element while parsing the markup-language-based page, the first dynamic segment markup language element specifying at least one attribute-value pair for establishing at least one default value for at least one attribute for dynamic markup language elements within the first dynamic segment markup language element.

12. The method of claim 11 comprising detecting, while parsing the markup-language-based page, a second dynamic segment markup language element included in the first dynamic markup language element, the second dynamic segment markup language element specifying at least one attribute-value pair for establishing at least one default value for at least one attribute for dynamic markup language elements within the second dynamic segment markup language element.

13. The method of claim 1 wherein at least one of the dynamic markup language element and content received from the update provider includes at least a portion of a script.

14. The method of claim 1 wherein sending a message to the remote update provider includes using a script included in the dynamic markup language element to send the message.

15. The method of claim 1 wherein sending a message to the remote update provider includes using code separate from the markup-language-based page and triggered by the detection of the dynamic markup language element to send the message.

16. The method of claim 1 wherein the markup-language-based page comprises a web page and wherein the client comprises a web browser.

17. A method for providing a markup-language-based page including dynamic content to a client browser, the method comprising:
receiving a message from a client for a markup-language-based page;
obtaining, in response to the message, a markup-language-based page, the markup-language-based page including a dynamic markup language element including presentation content, the dynamic markup language element identifying the included presentation content as dynamic to the client and specifying an update provider remote to the browser for providing updates to the presentation content; and
sending the markup-language-based page to the client.

18. The method of claim 17 wherein receiving a message from a client includes receiving a subscribe message from a web browser for subscribing to the web page.

19. The method of claim 17 wherein receiving a message from a client includes receiving a get message from a web browser for retrieving an instance of the web page.

20. The method of claim 17 wherein the dynamic markup language element comprises a markup language tag for defining content within the tag as dynamic.

21. The method of claim 17 wherein the dynamic markup language element comprises an attribute of a markup language tag, the attribute including a value for identifying content within the tag as dynamic.

22. The method of claim 17 wherein the dynamic markup language element specifies an alternate source for providing an update to the presentation content in a protocol different from that used by the update provider.

23. The method of claim 17 wherein the dynamic markup language element specifies at least one of a time interval at which updates should be obtained from the update provider, a re-occurring time at which updates to the presentation content should be obtained from the update provider, and a conditional expression including a condition that, when satisfied, triggers contacting of the update provider.

24. The method of claim 17 wherein the update provider identified by the dynamic markup language element comprises a request-response-based update provider.

25. The method of claim 17 wherein the update provider identified by the dynamic markup language element comprises a subscription-based update provider.

26. The method of claim 17 wherein the presentation content received from the update provider includes a script.

27. A method for providing dynamic updates to presentation content displayed by a client, the method comprising:
at an update provider:
receiving, from a client, and in response to the client detecting a dynamic markup language element including presentation content, the dynamic markup language element identifying the included presentation content as dynamic to the client and specifying the remote update provider, a message for an update to the presentation content;
generating, in response to the message, an update to the presentation content; and
sending the update to the client.

28. The method of claim 27 wherein the dynamic markup language element comprises a tag identifying content within the tag as dynamic.

29. The method of claim 27 wherein the dynamic markup language element comprises an attribute of a markup language tag, the attribute including a value for identifying content within the tag as dynamic.

30. The method of claim 27 wherein receiving a message from a client includes receiving a subscribe message from a web browser for subscribing to updates in the presentation content.

31. The method of claim 27 wherein receiving a message from a client includes receiving a get message from a web browser retrieving the update to the presentation content.

32. The method of claim 27 wherein the update includes an update to the dynamic markup language element in addition to the presentation content.

33. The method of claim 27 wherein the update includes an identifier for a new update provider for providing a subsequent update to the presentation content.

34. The method of claim 27 wherein the update includes content for altering an attribute of the dynamic markup language element.

35. The method of claim 27 wherein the update includes a script for defining presentation content to be displayed by the client.

36. A system for dynamically updating content in a markup-language-based page at a client, the system comprising:
a content handler for detecting, while parsing a markup-language-based page, a dynamic markup language element including presentation content, the dynamic markup language element identifying the included presentation content as dynamic to the client and specifying a remote update provider for providing an update to the presentation content;
a presentation controller for presenting at least a portion of the page including the presentation content; and
wherein the content handler is adapted to send a message to the remote update provider for an update to the presentation content, to receive an update to the presentation content from the remote update provider and to update the page by replacing at least a portion of the presentation content with the presentation content received from the remote update provider and wherein the presentation controller is adapted to present the updated page.

37. The system of claim 36 wherein the dynamic markup language element comprises a markup language tag for identifying content within the tag as dynamic.

38. The system of claim 36 wherein the dynamic markup language element comprises a markup language attribute, the attribute including a value for identifying content within the tag as dynamic.

39. The system of claim 36 wherein the content handler is adapted to send a subscribe message to the update provider for obtaining the update to the presentation content.

40. The system of claim 36 wherein the content handler is adapted to send a get message to the update provider for obtaining the update to the presentation content.

41. The system of claim 36 wherein the content handler is adapted to receive an update to the dynamic markup language element in addition to the presentation content.

42. The system of claim 36 wherein the content handler is adapted to receive an update that identifies a new update provider for providing a subsequent update to the presentation content.

43. The system of claim 36 wherein the update includes content for altering an attribute of the dynamic markup language element in addition to the presentation content.

44. The system of claim 36 wherein the dynamic markup language element specifies an alternate source for obtaining an update to the presentation content in a protocol different from that used by the update provider.

45. The system of claim 36 wherein the dynamic markup language element specifies at least one of a time interval at which the update provider should be contacted to obtain updates to the presentation content, a re-occurring time at which the update provider should be contacted for updates to the presentation content, and a conditional expression specifying a condition that, when satisfied, triggers the content handler to contact the update provider to obtain the update.

46. The system of claim 36 wherein the content handler is adapted to detect a first dynamic segment markup language element while parsing the markup-language-based page, the first dynamic segment markup language element specifying at least one attribute-value pair for establishing at least one default value for at least one attribute for dynamic markup language elements within the first dynamic segment markup language element.

47. The system of claim 46 wherein the content handler is adapted to detect, while parsing the markup-language-based page, a second dynamic segment markup language element included in the first dynamic segment markup language element, the second dynamic segment markup language element specifying at least one attribute-value pair for establishing at least one default value for at least one attribute for dynamic markup language elements within the second dynamic segment markup language element.

48. The system of claim 36 wherein at least one of the dynamic markup language element and content received from the update provider includes a script.

49. The system of claim 36 wherein, in sending a message to the remote update provider, the content handler is adapted to use a script included in the dynamic markup language element to send the message.

50. The system of claim 36 wherein, in sending a message to the remote update provider, the content handler is adapted to use code separate from the page and triggered by the detection of the dynamic markup language element to send the message.

51. The system of claim 36 wherein the markup-language-based page comprises a web page and wherein the client comprises a web browser.

52. A system for providing markup-language-based pages including dynamically updatable content to clients, the system comprising:
a server for receiving a message from a client for retrieving a markup-language based page;
a content generator for obtaining, in response to the message, a markup-language-based page, the markup-language-based page including a dynamic markup language element including presentation content, the dynamic markup language element identifying the included presentation content as dynamic to the client and specifying a remote update provider for providing an update to the presentation content; and
wherein the server is adapted to send the page to the client.

53. A system for providing updates to dynamic content being displayed by a client, the system comprising:
a server for receiving a message from a client for an update for content being presented by the client, the message being generated in response to the client detecting a dynamic markup language element including presentation content, the dynamic markup language element identifying the included presentation content as dynamic and specifying a remote update provider for providing an update to the presentation content;
a content generator for obtaining the update, the update including content for updating at least a portion of the presentation content being presented by the client; and
wherein the server is adapted to send the update to the client for updating at least a portion of the presentation content being presented by the client.

54. A system for dynamically updating content in a markup-language-based page at a client, the system comprising:
means for detecting, while parsing a markup-language-based page, a dynamic markup language element including presentation content, the dynamic markup language element identifying the included presentation content as dynamic to the client and specifying a remote update provider for providing updates to the presentation content;
means for presenting at least a portion of the page that includes the presentation content;
means for sending a message to the remote update provider for an update to the presentation content;
means for receiving an update from the update provider;
means for updating the page by replacing at least a portion of the presentation content with the presentation content received from the update provider; and
means for presenting at least a portion of the updated page.

55. A system for providing a markup-language-based page including dynamic content to a client, the system comprising:
means for receiving a message from a client for a markup-language-based page;
means for obtaining, in response to the message, a markup-language-based page, the markup-language-based page including a dynamic markup language element including presentation content, the dynamic markup language element identifying the included presentation content as dynamic to the client and specifying an update provider remote to the browser for providing updates to the presentation content; and
means for sending the page to the client.

56. A system for providing dynamic updates to presentation content displayed by a client, the system comprising:
at an update provider:
means for receiving, from a client, and in response to the client detecting a dynamic markup language element including presentation content, the dynamic markup language element identifying the included presentation content as dynamic to the client and specifying the remote update provider, a message for an update to the presentation content;
means for obtaining, in response to the message, an update to the presentation content; and
means for sending the update to the client.

57. A computer program product comprising computer executable instructions embodied in a computer readable medium for performing steps comprising:
detecting, while parsing a markup-language-based page, a dynamic markup language element including presentation content, the dynamic markup language element identifying the included presentation content as dynamic to a client and specifying a remote update provider for providing updates to the presentation content;
presenting at least a portion of the page that includes the presentation content;
sending a message to the remote update provider for an update to the presentation content;
receiving an update from the update provider;
updating the page by replacing at least a portion of the presentation content with the presentation content received from the update provider; and
presenting at least a portion of the updated page.

58. A computer program product comprising computer executable instructions embodied in a computer readable medium for performing steps comprising:
receiving a message from a client for a markup-language-based page;
obtaining, in response to the message, a markup-language-based page, the markup-language-based page including a dynamic markup language element including presentation content, the dynamic markup language element identifying the included presentation content as dynamic to the client and specifying an update provider remote to the browser for providing updates to the presentation content; and
sending the markup-language-based page to the client.

59. A computer program product comprising computer executable instructions embodied in a computer readable medium for performing steps comprising: at an update provider:
receiving, from a client, and in response to the client detecting a dynamic markup language element including presentation content, the dynamic markup language element identifying the included presentation content as dynamic to the client and specifying the remote update provider, a message for an update to the presentation content;
obtaining, in response to the message, an update to the presentation content; and
sending the update to the client.
